(19) United States
(12) Patent Application Publication
(10) Pub. No.: US 2018/0063920 A1
(43) Pub. Date: Mar. 1, 2018

(54) LIGHTING DEVICE FOR VEHICLES

(71) Applicant: ZKW GROUP GMBH, Wieselburg (AT)

(72) Inventors: Emanuel WEBER, Baden (AT); Dietmar KIESLINGER, Theresienfeld (AT); Martin BIESENBERGER, Persenbeug (AT)

(21) Appl. No.: 15/803,341

(22) Filed: Nov. 3, 2017

Related U.S. Application Data
(63) Continuation-in-part of application No. PCT/AT2016/050122, filed on May 3, 2016.

(30) Foreign Application Priority Data
May 8, 2015 (AT) A 50379/2015

(51) Int. Cl. H05B 37/02; H05B 33/08; H02M 3/158; B60Q 1/00

(52) U.S. Cl. CPC H05B 37/02; H05B 33/083; H02M 3/1582; F21S 48/1154; H05B 33/0881; H05B 33/0809; H05B 33/0887; B60Q 1/0088

(57) ABSTRACT

A method for symmetrising the branches of a lighting device for vehicles having at least two LED branches (ZW1, ZW2 . . . ZWn) connected in parallel. Each branch has at least one series resistor (R1 . . . Rn) and at least one LED (D11 . . . Dn2) connected in series. The at least one series resistor (R1 . . . Rn) of each branch is bridged by a conducting track (LA1 . . . LAn) provided on a printed circuit board. This conducting track is accessible for a tool of a depanelling device, with the aid of which said conducting track can be severed. The current through each branch and/or the brightness of at least one LED (D11 . . . Dn2) is measured in each branch, and in a branch in which the measured current and/or the measured brightness exceeds a definable limit value, the bridging conducting track of the at least one series resistor is severed with aid of the tool.

### CROSS-REFERENCE TO RELATED APPLICATIONS

This application is a continuation-in-part of PCT/AT2016/050122, filed May 3, 2016, which claims priority to Austrian Patent Application No. A 50379/2015, filed May 8, 2015, which are incorporated by reference herein.

### FIELD

The invention relates to a method for symmetrising the branches of a lighting device for vehicles having at least two LED branches connected in parallel, wherein each branch has at least one series resistor and at least one LED connected in series.

The invention also relates to a lighting device for vehicles having at least two LED branches connected in parallel, wherein each branch has at least one series resistor and at least one LED connected in series, said lighting device being designed to symmetrise the branches thereof in accordance with the method according to the invention.

### BACKGROUND

The use of LEDs as light source for vehicle lighting devices having different light functions not least offers new design possibilities with regard to the configuration of the individual light functions. A key parameter here is the number of LEDs used per light function. Due to the different designs for example of headlamps, the number of LEDs also varies significantly. Typical numbers in a normal case are one to ten LEDs operated in series per light function. The configuration of the current driver for LED series branches of this type is heavily dependent on the number of LEDs. Depending on the total voltage of the LED branch, a buck converter, a boost converter or a boost-buck converter must be used. However, this variety of necessary converter topologies prevents the use of cost-optimised standard solutions. For example, a buck converter can be designed to be significantly more cost-efficient than a boost-buck converter.

One approach for combining or reducing the LED voltage is constituted by the parallel connection of LED branches, whereby it is possible to work with low output voltages of the converters, with the advantage that buck converters of simple construction can be used. Depending on the number of LEDs, merely the output current varies, whereas the choice of topology is not significantly influenced. The problem with the parallel connection of LEDs or LED branches, however, lies in the symmetrisation of the LED currents, which is almost always necessary. Depending on the LED type, LED specification, LED binning class and also depending on the placement of the LEDs and thus the printed circuit board layout, different currents are provided by the individual LED branches. (The term “binning” is understood to mean a class division of LED production, for example with regard to brightness, luminous flux, colour, etc.). These different currents can lead to various disadvantages: the current asymmetry can lead to a thermal overloading of the LEDs and, associated therewith, a reduction of the service life of the LEDs. Different currents also result in different LED brightnesses and thus hinder the homogeneity of the light distributions.

Document DE 10 2013 111 510 A1 presents the parallel connection of LED branches with series resistors that can be bridged by switches, in particular so as to mitigate or compensate for the negative effect of manufacturing tolerances. These switches can optionally also be electronically switched by a control unit.

A switch, however, must be actuated either mechanically or electronically, which is certainly not easily possible in an automated manner when fitting components on a printed circuit board.

U.S. Pat. No. 6,172,480 B1, relates to a battery-charging apparatus, wherein, according to the cited prior art, a network of isolating resistors 13 is used to set the exact battery voltage. By drilling away a connection considered in the layout, trim elements are connected or disconnected. This can also be performed during a PCB test phase (not explained in greater detail). Nothing is mentioned, however, with regard to what this PCB test phase is. This document (D2) has nothing in common with the energising of LEDs.

WO 2014/023742 A2 concerns the parallel connection of LED branches which each contain a trimmable resistor element. These resistor elements can be thin-film or thick--film resistors, which can be trimmed by means of a laser. The described solution is relatively complicated, since on the one hand special resistors are required and on the other hand as laser tool is required for trimming.

EP 0942474 A2 describes the coding of an LED by three contact points which can be opened or closed in a way not described so that these LEDs can be connected to one of three series resistors arranged externally.

### BRIEF SUMMARY OF INVENTION

The object of the invention lies in describing a symmetrisation method and a lighting device which enable simple symmetrisation already at the time of manufacture so as to be able to work with comparatively low supply voltages and thus with cost-effective voltage converters and/or power supplies.

This object is achieved with a method of the above-described type, in which, in accordance with the invention, the at least one series resistor of each branch is bridged by a conducting track provided on a printed circuit board, wherein this conducting track is accessible for a tool of a depanelling device, with the aid of which the conducting track can be severed, and the current through each branch and/or the brightness of at least one LED in each branch is measured and the bridging conducting track of the at least one series resistor is severed with the aid of the tool in a branch in which the measured current and/or the measured brightness exceeds a definable limit value.

Here, it is often expedient if the series connection of a conducting track arranged on the printed circuit board and of a shunt resistor is connected in parallel to a series resistor.

It can also be provided expediently that each branch has at least two series resistors arranged in series, wherein at least one series resistor of each branch is bridged by a conducting track provided on a printed circuit board.

It can be particularly advantageous if a miller of a depanelling device for printed circuit boards is used as tool.

A development of the invention that is very expedient in practice provides that the conductor support is a printed circuit board, the conductor portions are formed as conducting tracks of the printed circuit board, and a depanelling device for printed circuit boards is used as tool.

The object is also achieved with a lighting device of the type described in the introduction, wherein, in accordance with the invention, the at least one series resistor of each branch is bridged by a conducting track provided on a printed circuit board, wherein this conducting track is accessible for a tool of a depanelling device, with the aid of which the conducting track can be severed.

In this way, it is possible to compensate for any asymmetries of the individual branches in a simple manner already during the course of manufacture.

In some cases it can also be expedient in the sense of a precise symmetrisation that the series connection of a conducting track arranged on the printed circuit board and of a shunt resistor is connected in parallel to a series resistor.

In another advantageous embodiment it can be provided that each branch has at least two series resistors arranged in series, wherein at least one series resistor of the branch is bridged by a conducting track provided on a printed circuit board.

### BRIEF DESCRIPTION OF DRAWINGS

The invention, inclusive of further advantages, will be explained in greater detail hereinafter on the basis of exemplary embodiments illustrated in the drawings, in which

FIG. 1 shows a first exemplary arrangement of LED branches connected in parallel, which each have two LEDs and a series resistor connected in series,

FIG. 2 shows the arrangement according to FIG. 1 once a conductor portion has been severed,

FIG. 3 shows an arrangement as in FIG. 1, but with two series resistors in each branch,

FIG. 4 shows an arrangement as in FIG. 1, but with four weighted series resistors in each branch, wherein a shunt resistor is indicated in one branch, and

FIG. 5 shows an arrangement as in FIG. 1, but with four weighted shunt resistors in each branch, wherein a series resistor is additionally indicated in one branch.

### DETAILED DESCRIPTION

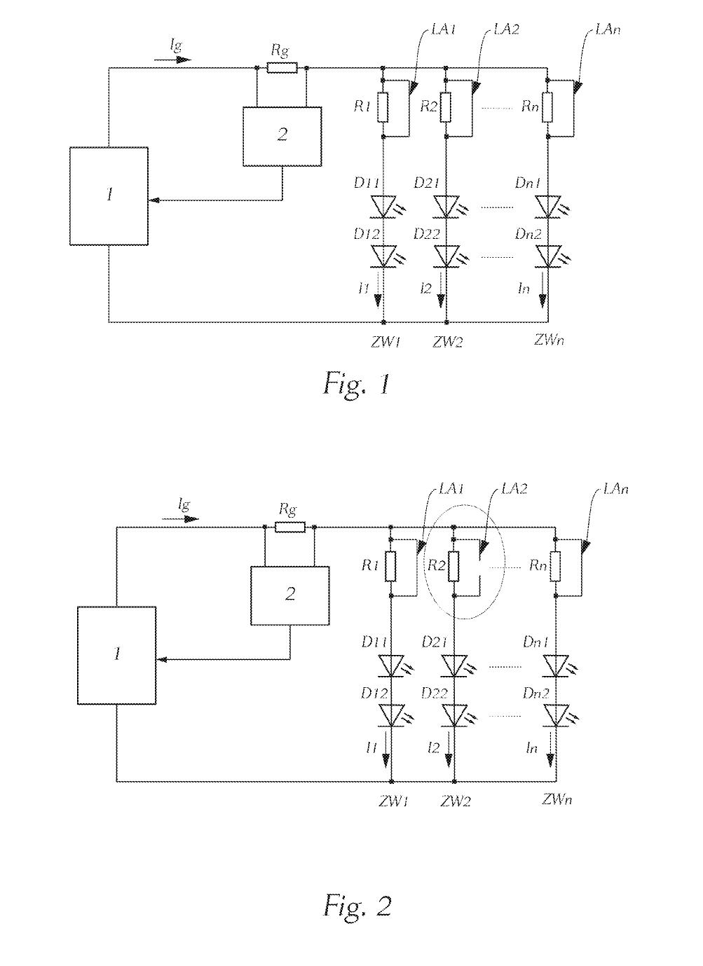

Reference will be made first to FIG. 1, which shows a number of branches ZW1, ZW2 . . . ZWn arranged in parallel of a lighting device for vehicles, wherein each branch in the present case contains a series resistor R1, R2 . . . Rn, which is arranged in series with, in the present case, two light-emitting diodes D11, D12; D21, D22 . . . Dn1, Dn2. The parallel connection of these branches ZW1 . . . ZWn is fed by a power supply 1, wherein this power supply is controlled for example by a differential amplifier 2, which detects the current flowing through a series resistor Rg. The power supply 1 is designed, together with the differential amplifier 2, to control the power supply to a predefinable constant current, and the power supply 1 contains a voltage source (not shown here), for example a motor vehicle battery. The power supply inclusive of the aforesaid control is known, however, and also does not form the subject matter of the present invention.

As can be deduced from FIG. 1, each of the series resistors R1, R2 . . . Rn is bridged by a conductor portion LA1, LA2 . . . LAn, wherein this conductor portion LA1 . . . LAn is provided on any conductor support of any form. In practical, tried and tested embodiments, the conductor portion is formed as a conducting track or conductor line on a printed circuit board, which can also carry other components, in particular the light-emitting diodes and the control or part of the control for the overall current Ig. Each conductor portion LA1 . . . LAn bridging the series resistors R1 . . . Rn is designed so that it can be easily severed by a tool, wherein it is clear that, once a corresponding conductor portion has been severed, for example the conductor portion LA2, the associated, bridged series resistor R2 is effective.

The solution to the problem stated in the introduction or the remedying of the disadvantages encountered in the prior art will be explained hereinafter firstly with reference to FIG. 1 and FIG. 2.

In order to allow cost-effective buck converters, LED branches are connected in parallel in groups, wherein a prerequisite for this is that the applied LED voltage of each branch in each operating state is lower than the lowest input voltage. In the case of a 12 volt on-board power supply system, the input voltage range is typically specified from 9 to 16 volts. With a typical maximum voltage of an LED of 3.5 volts, in this case only at most two LEDs in a strand can be operated, as is shown in FIGS. 1 and 2.

As already mentioned above, the problem with the parallel connection of LEDs lies in the fact of symmetrisation of the currents of the individual branches, wherein the total current Ig of the total LED arrangement is controlled. The actual current flowing through the respective LED branches is set on the basis of the LED forward voltages. However, this can mean significant differences in the LED brightness depending on the specification of the LEDs.

The series resistors R1 . . . Rn with the conductor portions which bridge them and which can be severed have values which are selected depending on the present LED specification. The power supply or control now controls the power supplied to a total current Ig of the LED arrangements, which is given from the addition of the individual LED branch currents I1, I2 . . . In, wherein the series resistors R1 . . . Rn are initially short-circuited via the conductor portions LA1 . . . LAn. These series resistors inclusive of the conductor portions formed as conducting tracks are generally disposed on the printed circuit board layout.

Once components have been fitted on the printed circuit board, but before the printed circuit boards are separated in a depanelling device, a parameter test is performed on the LEDs. To this end, the entire arrangement is acted on with a current Ig, for example via a needle adapter, and the individual LED branch currents I1 . . . In are measured. This can be performed either via an additional resistor in the LED branch or via a brightness measurement directly at the individual LEDs, wherein the brightness measurement has the advantage of a lower component effort, since there is no need to provide an additional measuring resistor for each branch.

If an asymmetry is determined during the course of this measurement, that is to say a difference between the individual branch currents or LED brightness values, which exceeds a certain tolerable maximum value, the LED current in the LED branches is reduced, in the event of an excessively high branch current or excessively high brightness, in that, in the case of the firstly bridged series resistor R1 . . . Rn, the bridging conductor portion is severed and therefore the corresponding series resistor is “released”. The conductor portion can be severed for example in a depanelling device, which is embodied as a miller and for example can mill a bore or blind bore in the printed circuit board so as to thus sever the conducting track or conductor portion. FIG. 2 shows a severed conductor portion of this kind in the branch ZW2, in which an excessively high current was measured beforehand. The released series resistor R2 now reduces the current in the branch and, after the depanelling, all LED branches are sufficiently symmetrised this, that is to say they conduct the same current within certain tolerance limits, so that the brightnesses of all LED branches are also the same or symmetrical accordingly.

The embodiment according to FIG. 3 is in principle the same as that according to FIG. 1 and FIG. 2, but is intended to show that more than one series resistor can be provided in each branch. In the present case, two series resistors R11, R12 . . . Rn1, Rn2 are provided in each branch. It is clear that a greater number of series resistors allow a more accurate symmetrisation. In the present example of FIG. 3, provided the resistance values of the series resistors of each branch disposed in series are different, a total of four different currents can be set.

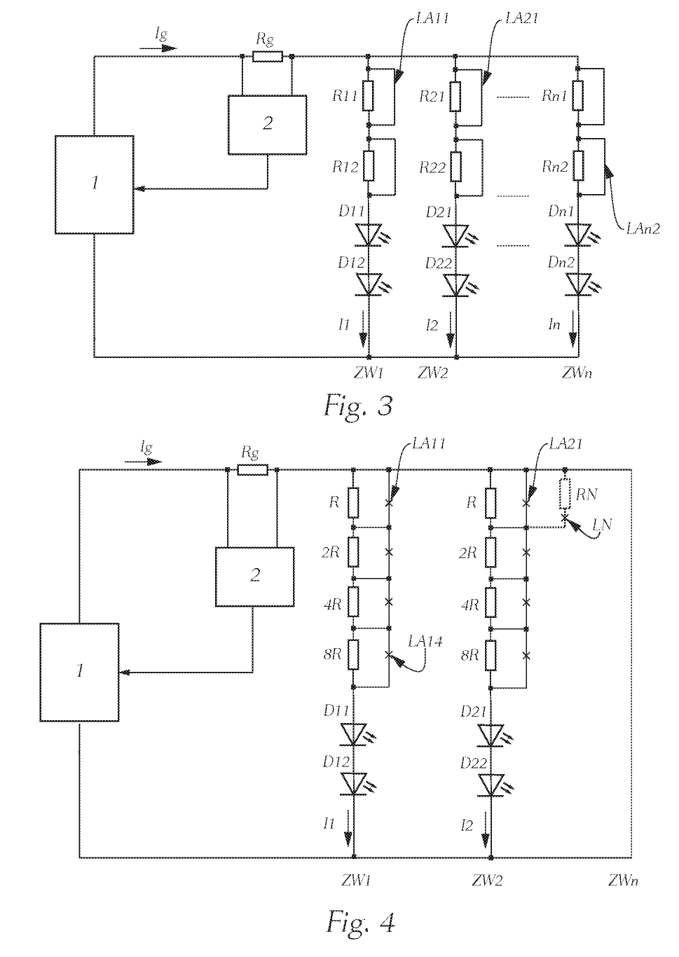

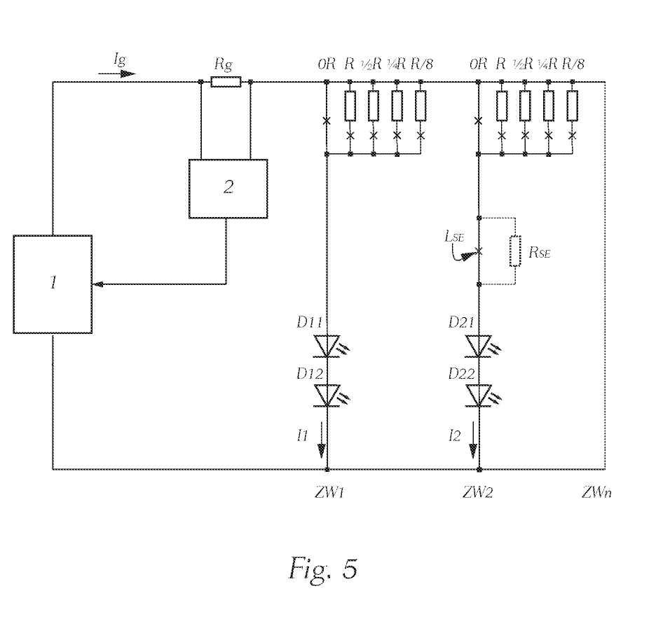

The following FIGS. 4 and 5 are intended to show that other combinations of resistors and conductor portions bridging these, up to resistor networks, are possible.

FIG. 4 shows that in each branch four series resistors with graduated resistance values R, 2R, 4R and 8R are arranged in series, so that, by severing the conductor portions LA11 . . . LA14, etc. disposed in parallel to the series resistors and short-circuiting them, a high number of combinations are possible for providing the corresponding series resistor resistance values for each branch. For the branch ZW2 it is shown that a series resistor, here the resistor R, can also be bridged by a further resistor, which is referred to here as a shunt resistor and is denoted by RN. This shunt resistor is also assigned a conductor portion LN in series, which conductor portion can be severed, whereby the parallel connection of the shunt resistor RN to the previous resistor R is cancelled. It is clear that an even finer graduation is possible in this way.

FIG. 5 shows, similarly to the previously described shunt resistor, a situation in which there is a parallel connection of four resistors and a conductor portion in each branch in series with the LEDs, here D11 and D12, wherein the resistors have the values R, ½R, ¼R, ⅛R or the short-circuiting conductor portion has the resistance value OR. Analogously to the series connection according to FIG. 4, a large number of combination possibilities are provided here for each LED branch. In FIG. 5 a series resistor RSE is additionally also shown here in the branch ZW2 in a dashed manner and is bridged by a conductor portion, wherein this conductor portion LSE likewise can be severed in order to make the series resistor RSE effective.

The resistors RN in FIG. 4 and RSE in FIG. 5 are merely intended to indicate that in principle more complex resistor networks are also to be understood under the expression “at least one series resistor”, wherein simpler configurations are understandably preferred in practice.

Although in the shown embodiments each branch contains two LEDs connected in series, this is not intended to rule out other LED configurations in each branch. It is also possible particularly in the case of higher on-board power supply voltages in vehicles, for example of 24 or 48 volts, to use more than two LEDs in one branch in spite of the use of inexpensive buck converters. Combinations of series and parallel connections of LEDs are also possible in principle in each branch.

Conductor lines can of course also be severed separately from the cutting-to-size of a panel, wherein, especially in the case in which the conductor lines are formed on printed circuit boards, said lines can be severed advantageously by means of a laser tool.

1. A method for symmetrising the branches of a lighting device for vehicles having at least two LED branches (ZW1, ZW2 . . . ZWn) connected in parallel, wherein each branch has at least one series resistor (R1 . . . Rn) and at least one LED (D11 . . . Dn2) connected in series,
wherein the at least one series resistor (R1 . . . Rn) of each branch is bridged by a conducting track (LA1 . . . LAn) provided on a printed circuit board, wherein this conducting track is accessible for a tool of a depanelling device, with the aid of which said conducting track can be severed,
wherein the current through each branch and/or the brightness of at least one LED (D11 . . . Dn2) is measured in each branch, and
wherein in a branch in which the measured current and/or the measured brightness exceeds a definable limit value, the bridging conducting track of the at least one series resistor is severed with the aid of the tool.

2. The method according to claim 1, wherein the series connection of a conducting track (LN) arranged on a printed circuit board and of a shunt resistor (RN) is connected in parallel to a series resistor (R).

3. The method according to claim 1, wherein each branch (ZW1 . . . ZWn) has at least two series resistors (R11, R12 . . . Rn1, Rn2) arranged in series, wherein at least one series resistor of each branch is bridged by a conducting track (LA11 . . . LAn2) provided on a printed circuit board.

4. The method according to claim 1, wherein a miller of a depanelling device for printed circuit boards is used as tool.

5. A lighting device for vehicles, the device comprising:
at least two LED branches (ZW1, ZW2 . . . ZWn) connected in parallel, wherein each branch has at least one series resistor (R1 . . . Rn) and at least one LED (D11 . . . Dn2) connected in series, wherein the lighting device is configured to symmetrise the at least two LED branches in accordance with a method according to claim 1,
wherein the at least one series resistor (R1 . . . Rn) of each branch (ZW1 . . . ZWn) is bridged by a conducting track (LA1 . . . LAn) provided on a printed circuit board, and
wherein the conducting track is accessible for a tool of a depanelling device, with the aid of which said conducting track can be severed.

6. The lighting device according to claim 5, wherein the series connection of a conducting track (LN) arranged on the printed circuit board and of a shunt resistor (RN) is connected in parallel to a series resistor (R).

7. The lighting device according to claim 5 wherein each branch (ZW1 . . . ZWn) has at least two series resistors (R11, R12 . . . Rn1, Rn2) arranged in series, wherein at least one series resistor of the branch is bridged by a conducting track (LA11 . . . LAn2) provided on a printed circuit board.
